(19) United States
(12) Patent Application Publication
(10) Pub. No.: US 2024/0202656 A1
(43) Pub. Date: Jun. 20, 2024

(54) INTELLIGENT AUTONOMOUS UNIT LOAD DEVICE CONTROL

(71) Applicant: International Business Machines Corporation, Armonk, NY (US)

(72) Inventors: Siddhartha SOOD, Ghaziabad (IN); Sandip GOSWAMI, Kolkata (IN); Rahul ROY, Kolkata (IN); Biswanath MUKHERJEE, Kolkata (IN); Jaydeep SARKAR, Kolkata (IN)

(21) Appl. No.: 18/068,275

(22) Filed: Dec. 19, 2022

(51) Int. Cl. G06Q 10/087

(52) U.S. Cl. CPC G06Q 10/087

(57) ABSTRACT

An enhanced system and methods implement intelligent decision making autonomous control of Unit Load Devices (ULDs) within a prescribed airport perimeter, such as an airport. An Intelligent Autonomous ULD Control Tower (IAUCT) receives demands for ULDs, maintains a ULD repository data store, and controls ULDs within the prescribed airport perimeter. The IAUCT identifies at least a ULD state and a specific ULD position for the ULD within a prescribed airport perimeter, and stores the ULD state and specific ULD position in a ULD repository data store. The IAUCT selects a next action for the ULD based upon the demand for ULDs and based upon the ULD state and specific ULD position and the demand for ULDs within the perimeter area. The IAUCT dynamically identifies an optimized route for moving the ULD within the prescribed airport perimeter based upon the selected next action.

### BACKGROUND

The present invention relates to positioning unit load devices, and more specifically, to a system and methods for implementing intelligent decision making autonomous control of Unit Load Devices (ULDs).

A ULD is a container often used to load luggage, freight, mail, and the like on an aircraft, such as wide-body aircrafts and specific narrow-body aircrafts. The ULD allows preloading of cargo, ensures the containerized load will fit in the aircraft, and offers efficient planning of aircraft weight and balance and reduced labor and time in loading aircraft holds as compared with bulk-loading single items of cargo or luggage by hand. Each ULD has its own packing list or manifest so that its contents can be tracked. A loaded aircraft cargo pallet secured with a cargo net also forms a ULD, but its load must be gauged for size in addition to being weighed to ensure compatibility with aircraft door and hold clearances.

Due to advancement in ULD technologies and rise in the number of cargo airlines, the number of ULDs to be managed within an airport is growing at a fast rate. Once unloaded from the aircraft and emptied of baggage and cargo, there are more ULDs to be stored while the basic space at the airport to manage the ULDs remains static. Challenges to control ULD handling operations are increasing, such as ULD allocation, deallocation, usage, movement, storage and maintenance within a prescribed airport perimeter.

Existing systems fail to meet the ongoing challenges to control ULD handling operations. New techniques and a system are needed for efficiently implementing intelligent decision making autonomous control of ULDs that overcome deficiencies of current systems.

### SUMMARY

An enhanced disclosed system and methods implement intelligent decision making autonomous control of Unit Load Devices (ULDs) within a prescribed airport perimeter. A non-limiting computer-implemented method comprises providing an Intelligent Autonomous ULD Control Tower (IAUCT), the IAUCT identifies at least a ULD state and a specific ULD position for the ULD within the prescribed airport perimeter, and stores the ULD state and specific ULD position in a ULD repository data store. The IAUCT receives a demand for an allocation of one or more ULDs within the prescribed airport perimeter. The IAUCT selects a next action for the ULD based upon the demand for allocation of ULDs and based upon the stored ULD state and specific ULD position within the prescribed airport perimeter. The IAUCT dynamically identifies an optimized route for moving the ULD within the prescribed airport perimeter based upon the demand and selected next action.

Other disclosed embodiments include a computer control system and computer program product for implementing intelligent decision making autonomous control of ULDs implementing features of the above-disclosed method.

### BRIEF DESCRIPTION OF THE DRAWINGS

FIG. 1 is a block diagram of an example computer environment for use in conjunction with one or more disclosed embodiments for implementing positioning control of Unit Load Devices (ULDs) within a prescribed perimeter;

FIGS. 2A and 2B together provide a schematic and block diagram of an example system for implementing intelligent decision making positioning control of multiple ULDs within a prescribed perimeter in accordance with one or more disclosed embodiments;

FIGS. 3A, and 3B together provide a flow chart illustrating example operations of a disclosed method for implementing intelligent decision making positioning control of ULDs within a perimeter area in accordance with one or more disclosed embodiments; and

FIGS. 4A, 4B, 4C, 4D, 4E, and 4F together provide a flow chart illustrating further example operations of a disclosed method for implementing intelligent decision making control of ULDs in accordance with one or more disclosed embodiments.

### DETAILED DESCRIPTION

An enhanced system and methods implement intelligent decision making autonomous control of Unit Load Devices (ULDs) within a prescribed airport perimeter, such as an airport. An Intelligent Autonomous ULD Control Tower (IAUCT) receives demands for ULDs, maintains a ULD repository data store, and controls ULDs within a prescribed airport perimeter. In a disclosed non-limiting method, the IAUCT identifies at least a ULD state and a specific ULD position for the ULD within a prescribed airport perimeter, and stores the ULD state and the specific ULD position in a ULD repository data store. For example, the ULD state may include either a ULD full or empty status. The ULDs can be fitted with load and weight sensors or can leverage palletized weight measuring arrangements to determine whether the ULD is empty or not. Further, ULD state includes ULD health status or condition, whether the ULD is in good condition or the ULD needs repair. For example, the ULD health condition can be determined through visual identification enabled by a ULD damage domain-specific machine-learning model. The IAUCT maps ULDs with carrier demands based upon identified ULD load and health status and its geographic location within the prescribed airport perimeter. For example, when the centralized IAUCT receives a demand for an empty ULD from any carrier, the IAUCT connects one empty ULD with the incoming demand. The IAUCT controls the delivery of an empty ULD to the carrier demand location within the perimeter area. For example, the IAUCT system can program an associated ULD transport autonomous vehicle at the airport with a starting location, such as an Empty ULD Parking Hub, where the empty ULD is placed for pickup and a target location such as an ULD Loading Hub, where the carrier aircraft is waiting for the ULD to be loaded.

In accordance with disclosed embodiments, the IAUCT selects a next action (i.e., next best action) for the ULD based on the ULD state and the specific ULD position and the current demand for ULDs. The IAUCT dynamically identifies an optimized route for moving the ULD within the prescribed airport perimeter based upon ULD state and the specific ULD position and the current demand within the prescribed airport perimeter. The IAUCT can coordinate and execute a next best action on the ULD based on current ULD state and the specific ULD position and the current demand. The IAUCT can determine an optimal route for ULD pickups and delivery based on the current demand within a perimeter area. In one embodiment, the IAUCT provides an autonomous vehicle to pick-up and deliver one or more ULDs to a desired destination within the prescribed airport perimeter based on the identified optimal route. The IAUCT optimizes availability and a ULD starting location within the perimeter area after a specific ULD receives maintenance or is repaired to reduce empty ULD time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

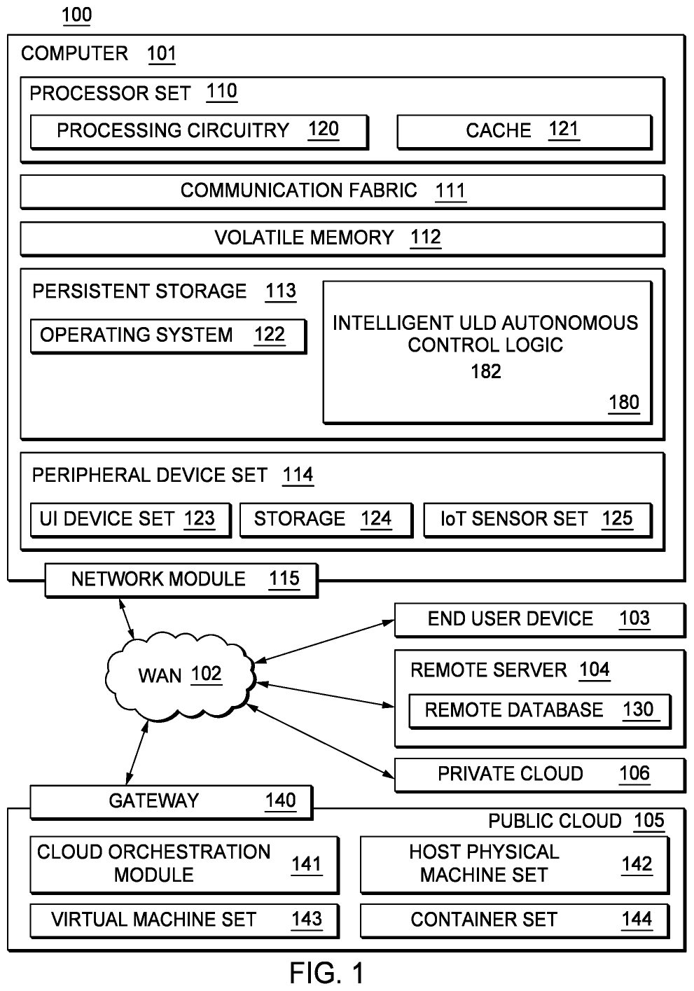

Referring to FIG. 1, computing environment 100 contains an example of an environment for the execution of at least some of the computer code involved in performing the inventive methods, such as Intelligent ULD Autonomous Control Logic 182 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

An enhanced system and methods implement intelligent decision making autonomous control of Unit Load Devices (ULDs) within a prescribed airport perimeter, such as an airport. The enhanced system includes a centralized Intelligent Autonomous ULD Control Tower (IAUCT) that receives requests for ULDs, maintains a ULD repository data store of ULD information, and manages ULDs within the prescribed airport perimeter.

In one non-limiting method, the IAUCT identifies at least a ULD state and a specific ULD position for the ULD within a prescribed airport perimeter. The IAUCT stores the ULD status and the specific ULD position in a ULD repository data store. For example, the ULD state includes the ULD status of full or empty, where the ULDs are either fitted with load/weight sensors or can leverage palletized weight measuring arrangements to determine whether the ULD is empty or not. Further, the ULD state includes whether the ULD is in good condition or needs repair, for example determined through visual identification backed by a ULD damage domain specific machine-learning model. Mapping ULDs with carrier demands based upon ULD load sensor status and ULD geographic location within the prescribed airport perimeter enables the IAUCT to identify optimum routes for moving one or more selected ULDs for a demand for UDL allocation received from any carrier. For example, the IAUCT receives a demand for an empty ULD from one specific carrier, and connects one empty smart ULD with the incoming demand using an optimized route. The IAUCT controls the delivery of an empty ULD to the carrier demand location within the perimeter area. For example, the IAUCT system programs an associated autonomous vehicle at the airport with the from-location, such as an Empty ULD Parking Hub, where the empty smart ULD is placed for pickup and to-location such as an ULD Loading Hub, where the carrier aircraft is waiting for the ULD to be loaded.

The IAUCT can create a current ULD record for a specific ULD within the prescribed airport perimeter including a ULD state and a specific ULD position for the specific ULD that can be stored in the ULD repository data store. The IAUCT can dynamically identify an optimized route for moving the ULD within the prescribed airport perimeter based upon the stored ULD profile and information, and requirements of a received demand for ULDs within the prescribed airport perimeter. The IAUCT can coordinate and execute a next best action on a specific ULD based on its current ULD state and position within the prescribed airport perimeter. The IAUCT can identify one or more optimal routes for ULD pickups and delivery based on demand within a perimeter area and ULD availability.

The IAUCT can schedule an autonomous vehicle to pick up and deliver ULDs to a desired destination within the prescribed airport perimeter based on the identified optimal routes. The IAUCT manages and optimizes availability and ULD starting location within the prescribed airport perimeter based on stored ULD state and position for ULDs, which can include one or more specific restored or repaired ULDs and based on current and historical information for demands. The IAUCT identifies a predefined or best route of ULD pickup to meet a received demand within perimeter area. The autonomous vehicle reaches the empty ULD location, based upon the predefined route within the airport perimeter, picks up the empty ULD, notifies the centralized IAUCT of the pickup state and then moves directly to the to-location, for example where the carrier is waiting. This to-location could be for loading the ULD directly onto a plane or to carrier specific warehouse locations where the ULDs will be loaded with packages.

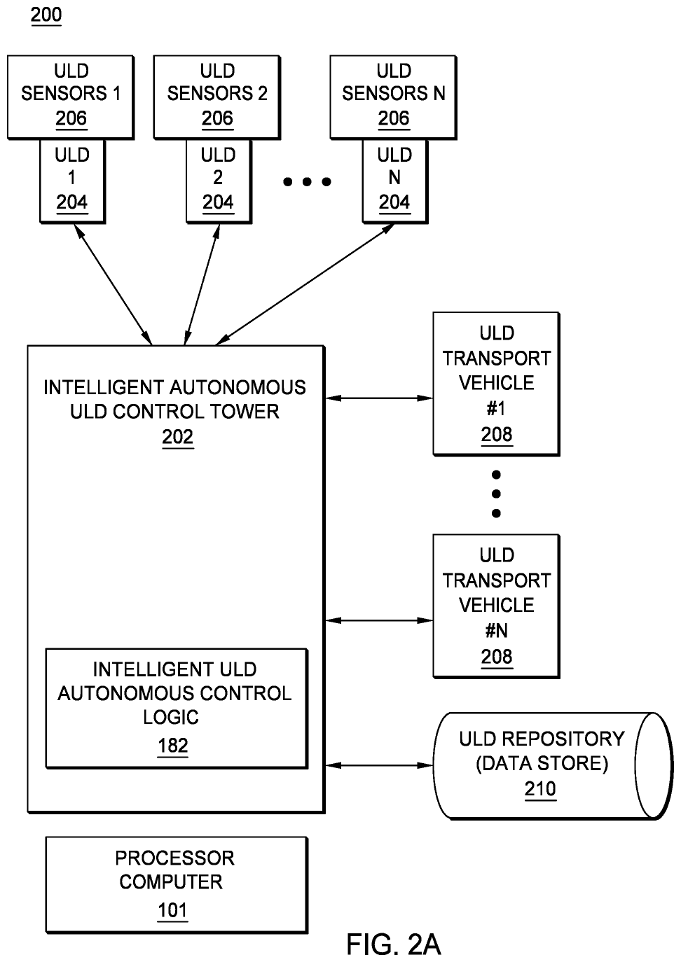

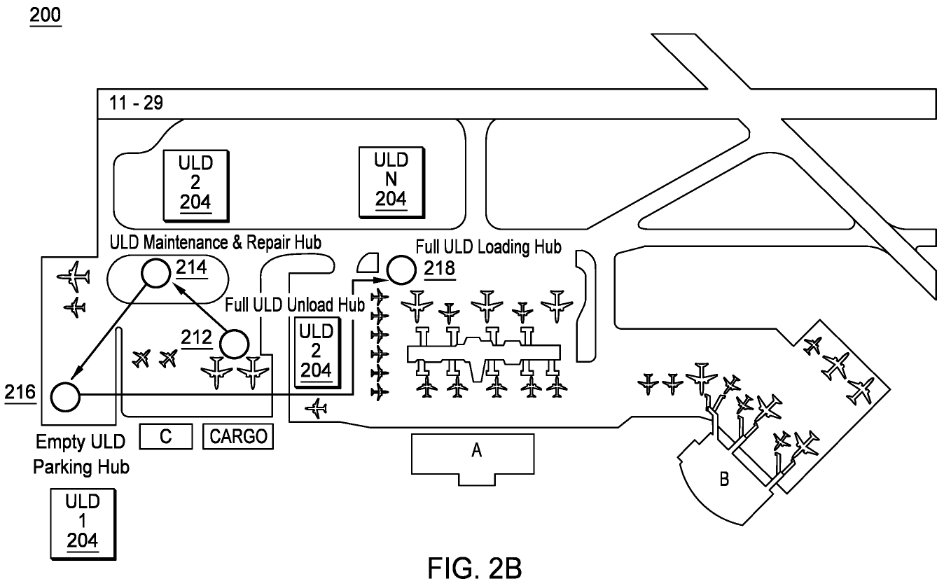

Referring to FIGS. 2A and 2B, an example system 200 implements intelligent decision making autonomous control of multiple ULDs within a prescribed perimeter in accordance with one or more disclosed embodiments. System 200 can be used in conjunction with computer 101 and cloud environment of the computing environment 100 of FIG. 1 for implementing intelligent decision making autonomous control of multiple ULDs of disclosed embodiments. System 200 includes an Intelligent Autonomous ULD Control Tower (IAUCT) 202, and the Intelligent ULD Autonomous Control Logic 182 of the computing environment 100 of FIG. 1 that receives demands for ULDs, manages and controls ULDs within a prescribed airport perimeter. System 200 includes a plurality of ULDs, 204, 1-N each including associated ULD sensors, 206, 1-N such as IoT sensors and geo-sensors. System 200 includes a plurality of associated autonomous vehicles 20208 1-N used by IAUCT 202 to pick up and deliver ULDs to a desired destination within a perimeter area, such as illustrated in FIG. 2B. System 200 includes an ULD repository data store 210 that stores predefined ULD state and location profiles and ULD information, such as ULD location within the airport perimeter area, the ULD state of empty, partial empty, or full, ULD condition such as maintenance or repair status, and the like. The IAUCT 202 maintains the ULD repository data store, storing current and historical ULD information and current and historical demand information.

As illustrated in FIG. 2B, system 200 includes for example an airport perimeter area including a full ULD unload hub 212, a ULD maintenance and repair hub 214, an empty ULD parking hub 216, and a full ULD loading hub 218. Multiple ULDs, 204, 1-N are located at various hubs within the airport perimeter area, and managed by IAUCT 202. As shown in the example of FIG. 2B, a ULD 204, 1 is located at the empty ULD parking hub 216, a ULD 204, 2 is located at the ULD maintenance and repair hub 214, and a ULD 204, N is located at the full ULD loading hub 218.

For example, in operation of system 200 a full ULD 204 can be emptied at the ULD unload hub 212 within the airport perimeter. The ULDs 204, 1-N are enabled with sensors 206, such as multiple IoT sensors and geo-sensors providing predefined monitored information (e.g., ULD load, health status and ULD geographic location) to the IAUCT 202. The IAUCT 202 controls moving the ULDs 204, for example identified ULDs 204 can be moved to the ULD maintenance and repair hub 214 where, using for example drone-based capabilities and associated sensors, these ULDs can be scanned for any physical damage in real time. If some or all of the ULDs are in good condition, the IAUCT 202 can control moving the ULDs in good condition to the empty ULD parking hub 216 to wait for a next allocation. Whenever the IAUCT 202 receives a demand for an empty ULD allocation, one or more ULDs can be moved to the target ULD loading hub 218. In the case where there is a ULD allocation demand pending assignment, leveraging the intelligent sensors and geo-location of each ULD 204 the IAUCT 202 can identify and move the empty ULDs directly from the ULD maintenance and repair hub 214 to the target ULD loading hub 218.

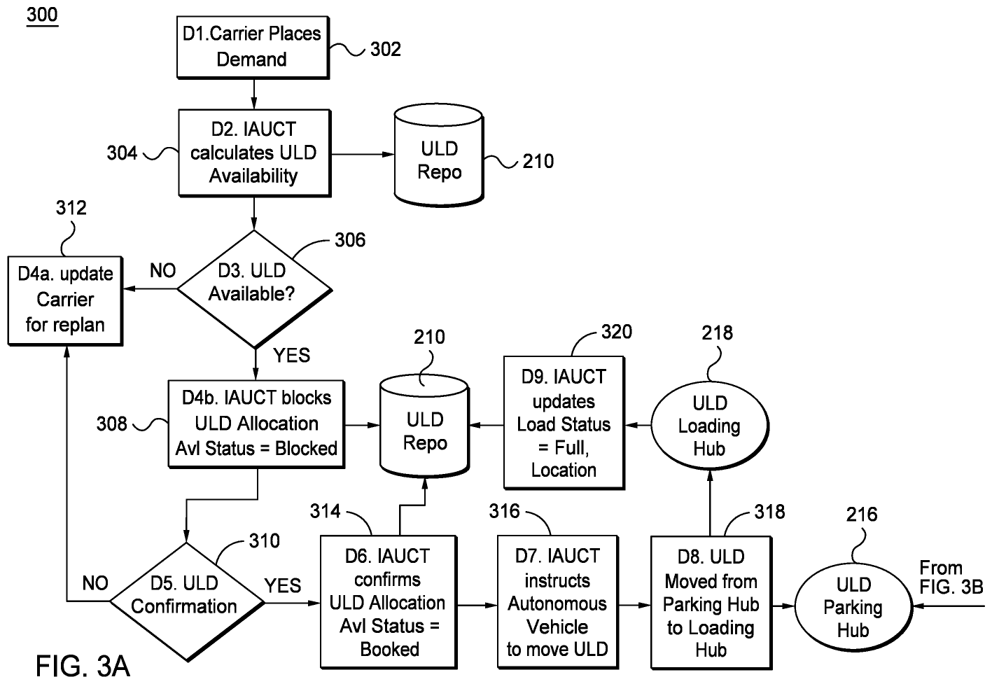

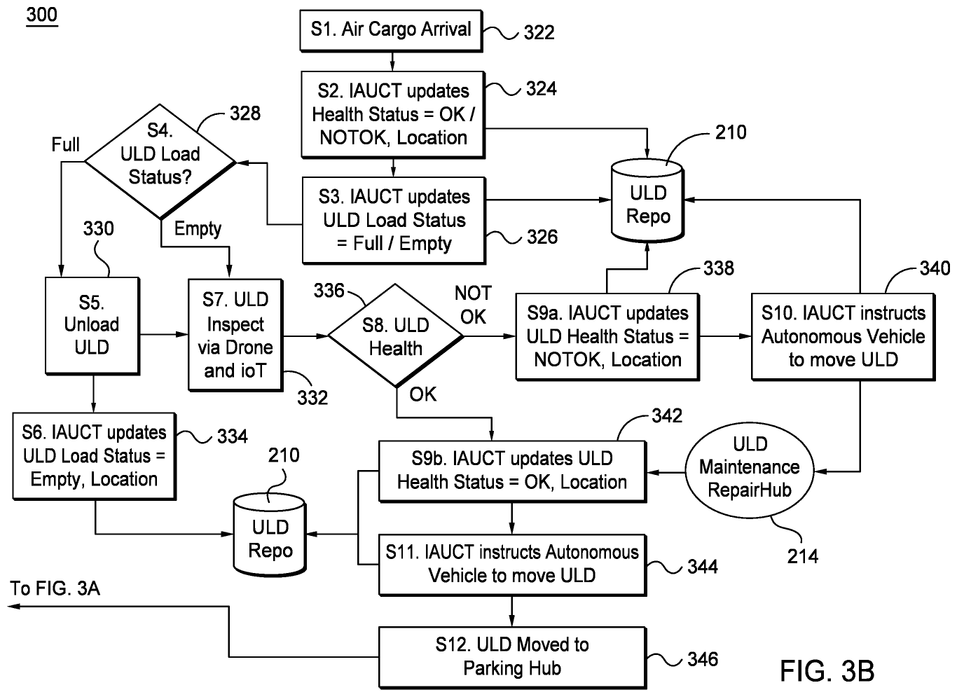

Referring also to FIGS. 3A, and 3B, example operations are shown of an example computer-implemented method 300 for implementing intelligent decision-making control of ULDs within a perimeter area in accordance with one or more disclosed embodiments. Method 300 may be implemented with computer 101 for example; with operations of method 300 controlled by the IAUCT 202 and Intelligent ULD Autonomous Control Logic 182.

As shown, method 300 begins as indicated at block 302 where the IAUCT 202 receives a carrier demand for a required number of ULDs, types and a location. At block 304, the IAUCT 202 calculates ULD availability based on predefined information accessed in the ULD repository data store 210. At decision block 306. the IAUCT 202 checks for ULD availability. At block 308, when ULDs are available as per the demand the IAUCT 202 blocks ULD allocation to avoid overbooking and informs the Carrier to provide confirmation. At decision block 310, the IAUCT 202 provides the Carrier with an option to confirm or cancel the ULD allocation and optionally can provide information based on predetermined factors like cost and other related factors. When the Carrier fails to confirm the reservation within a given time limit, the IAUCT 202 can cancel the reservation and release the blocks on the ULDs. At block 312, when a match or partial match is not found at decision block 306, the IAUCT 202 notifies the carrier of the need to modify the current demand or re-plan, for example along with notifying an end customer to modify the demand.

At block 314 once the Carrier confirms the ULD reservation, the IAUCT 202 updates the ULD availability status, confirming the ULD allocation and saves in the ULD repository data store 210. At block 316, the IAUCT 202 instructs autonomous vehicles to move the empty ULDs, for example from the Parking Hub to Loading Hub on the desired date and time, and saves the ULD information in the ULD repository data store 210. The IAUCT 202 updates the ULD state at each phase of the lifecycle based on the events received and processed. At block 318, the IAUCT 202 also provides the inputs for appropriate path identification to the autonomous vehicles, such as to move from the ULD loading hub to the ULD parking hub 218. At block 320, the IAUCT 202 updates the ULD state to full and updates the ULD location, and saves the updates in the ULD repository 210.

Referring also to FIG. 3B, as indicated at block 322, the IAUCT 202 notices the arrival of a Cargo flight. At block 324, the IAUCT 202 updates current ULD information such as ULD availability, ULD state (i.e., load and health status), and ULD location data for ULDs that arrived with the Cargo flight. At block 326, the IAUCT 202 updates ULD load status of full or empty of the ULD. At decision block 328 S4, the IAUCT 202 checks the ULD load state. At block 330, the IAUCT 202 with a full ULD identified, the IAUCT 202 sends the full ULD to be unloaded At block 332, in one embodiment, the IAUCT 202 inspects empty ULDs automatically, such as via drone or IoT devices installed on the empty ULDs. At block 334 after the ULDs are unloaded, the IAUCT 202 updates the ULD load state. In general, the IAUCT 202 may update the ULD load states at each step based on the event received by the IAUCT 202 and save the updated ULD load states to the ULD repository 210.

At decision block 336, the IAUCT 202 checks the ULD health status. At block 338 S9a, when determining at least some ULDs require repair work, the IAUCT 202 updates the health status of ULDs to the repository 210. At block 340 S10, the IAUCT 202 instructs an autonomous vehicle to move the damaged ULD to the Maintenance and Repair Hub 214, and the IAUCT 202 saves updated ULD status to the ULD repository 210. At block 342, after repairing the ULD (or when the ULD does not require any repair work), the IAUCT 202 updates the health status of the ULD and the ULD location to the centralized ULD repository 210. At block 344, the IAUCT 202 instructs the autonomous vehicle (or multiple autonomous vehicles) to move the ULDs to the ULD Parking Hub 216, and updates the ULD health and location status to the centralized ULD repository 210. At block 346, the ULDs are moved for example to the Parking Hub 216 shown in FIG. 3A.

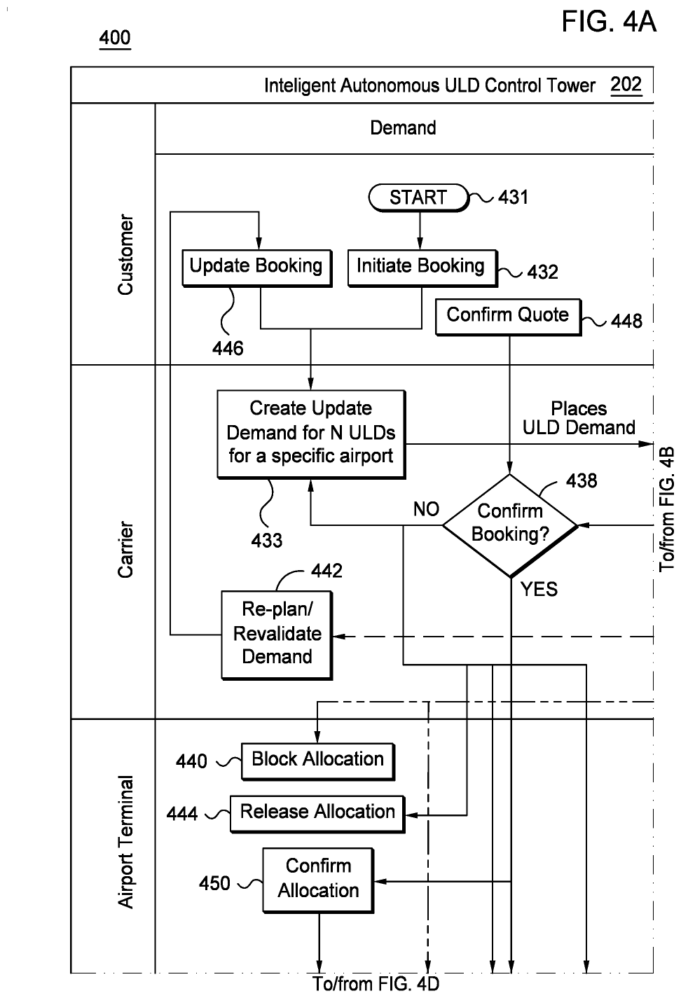

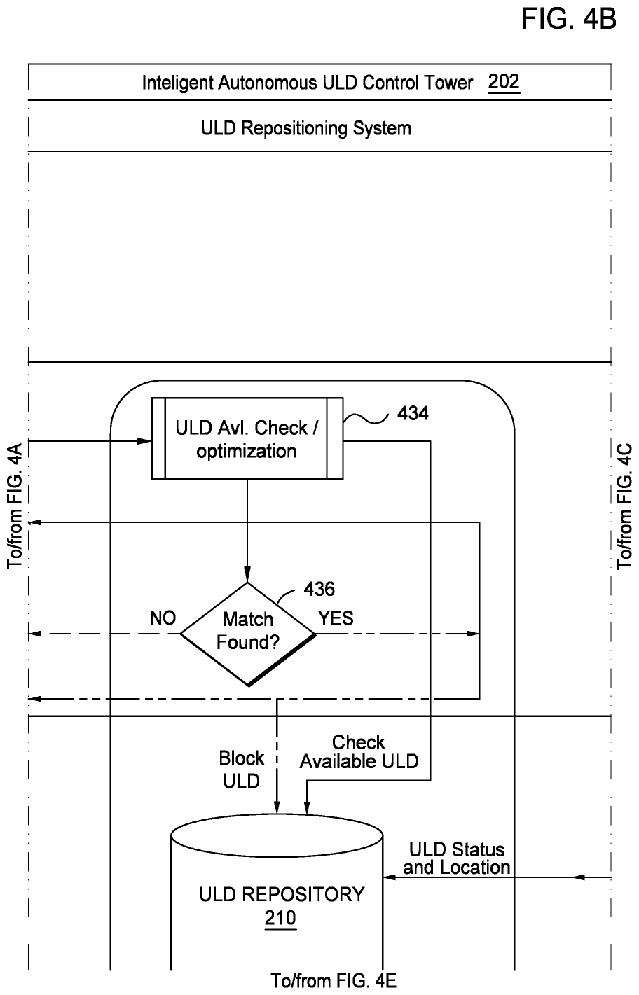

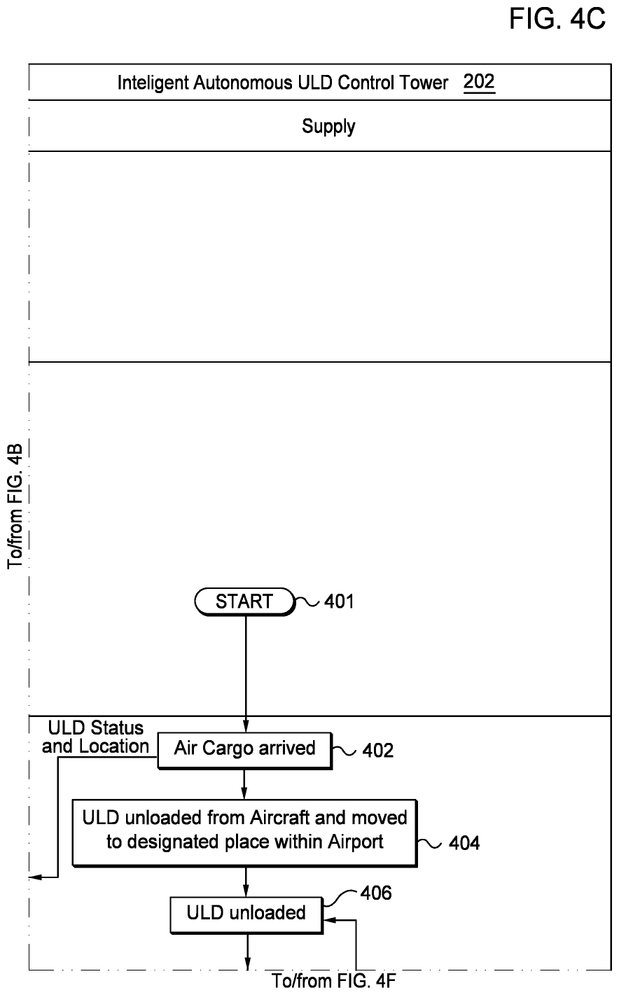

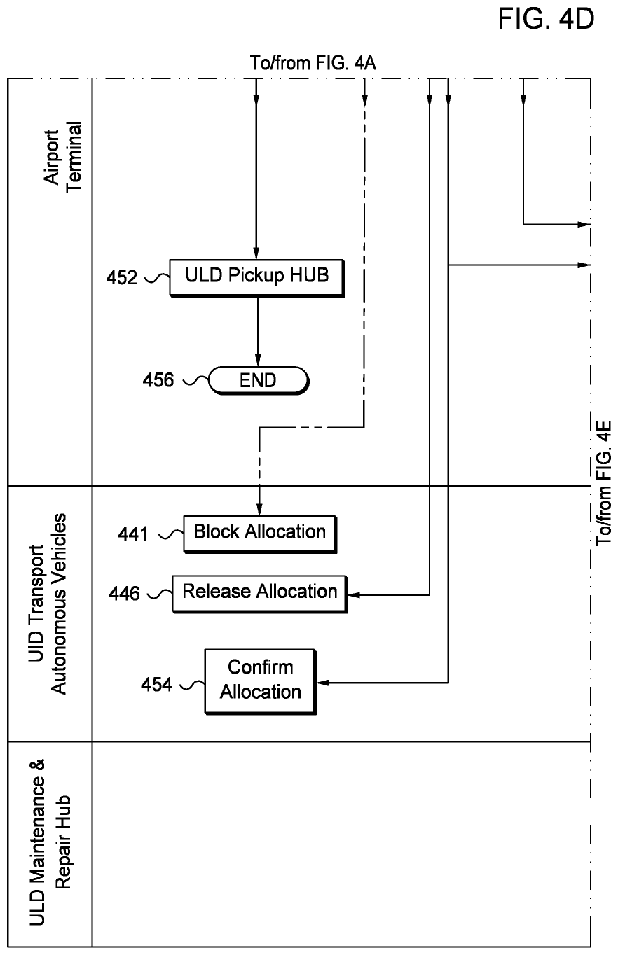

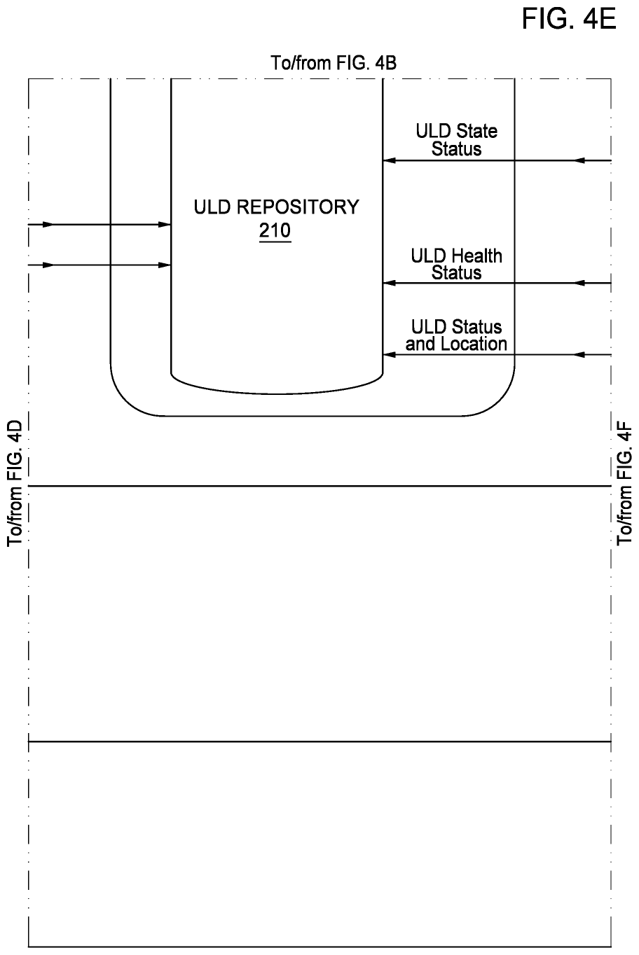

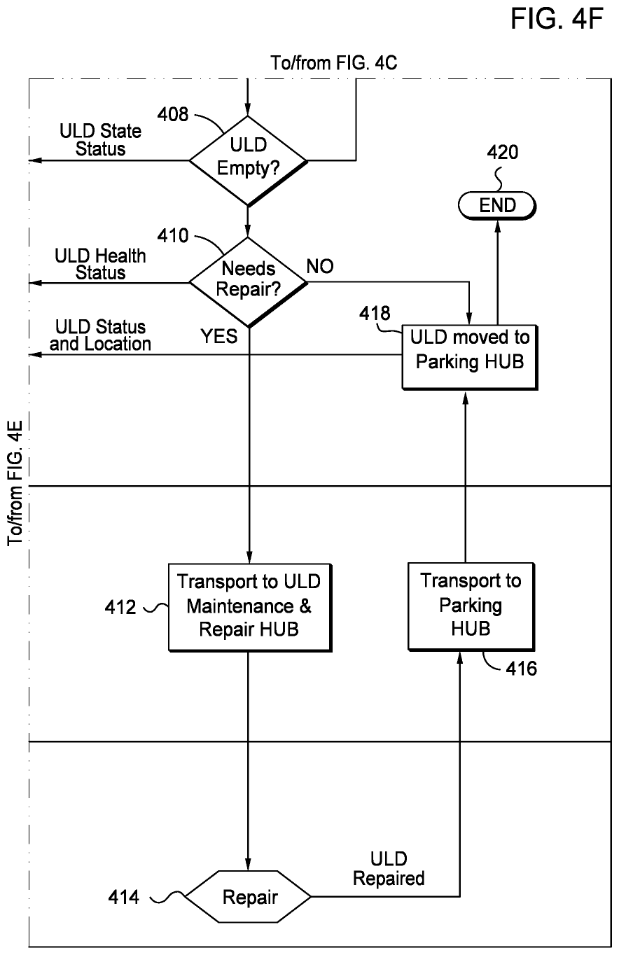

FIGS. 4A, 4B, 4C, 4D, 4E and 4F illustrate further example operations of an example computer-implemented method 400 for implementing intelligent decision-making control of ULDs of one or more disclosed embodiments. Method 400 may be implemented with computer 101 for example with operations of method 400 controlled by the IAUCT 202 and Intelligent ULD Autonomous Control Logic 182.

FIGS. 4A, 4B, 4C, 4D, 4E and 4F illustrate the IAUCT 202 with example operations shown relative to a Customer or user, a Carrier, such as any airline carrier or cargo, an Airport Terminal or prescribed airport perimeter, ULD Transport Autonomous Vehicles, such as ULD transport vehicles 208, and the ULD Maintenance & Repair Hub. FIGS. 4A and 4D include respective labels located along the left side of Customer, Carrier, Airport Terminal, ULD Transport Autonomous Vehicles, and ULD Maintenance & Repair Hub indicating respective entities associated with the example operations. FIGS. 4A, 4B, and 4C illustrate the Intelligent Autonomous ULD Control Tower 202 followed by respective labels of “Demand” in FIG. 4A, “ULD Repositioning” in FIG. 4B, and “Supply” in FIG. 4C.

Referring now to FIG. 4C, the ULD Supply process operations of method 400 start at block 401. At block 402, the IAUCT 202 is notified when an Air Cargo carrier arrives at a destination airport with loaded ULDs and the IAUCT 202 saves the identified ULD state and location to the ULD Repository Data Store 210 shown at line labeled ULD Status and Location in FIG. 4B. In one embodiment, in all ULD events of respective example operations of Demand, ULD Repositioning, and Supply in FIGS. 4A, 4B, 4C, 4D, 4E and 4F, the IAUCT 202 saves and updates ULD state and position of the ULD in the ULD Repository Data Store 210.

At block 404, the IAUCT 202 controls operations of unloading of ULDs from the aircraft and moving the ULDs to designated places within the airport through autonomous vehicles. As shown at block 406 in FIG. 4C, the ULDs are unloaded, and example operations continue to FIG. 4F at decision block 408.

In FIG. 4F at decision block 408, the IAUCT 202 checks whether the ULDs are empty. The IAUCT 202 saves the identified ULD state to the ULD Repository Data Store 210 shown in FIG. 4E at line labeled ULD State Status. At decision block 410, the IAUCT 202 automatically inspects the ULD using the associated ULD sensors 206, such as IoT and geo-sensors, and optionally drones, and the IAUCT 202 checks whether any of the ULDs need repair. The IAUCT 202 saves the identified ULD repair needed or health status to the ULD Repository Data Store 210 shown in FIG. 4E at line labeled ULD Health Status. At block 412, if the ULDs require repair then, the IAUCT 202 controls moving these ULDs to the ULD Maintenance & Repair Hub 214 via the ULD Transport autonomous vehicles 208. At block 414, the IAUCT 202 controls repair of the ULDs. At block 416, once repaired the IAUCT 202 instructs ULD Transport autonomous vehicles 208 to move these ULDs to the ULD Parking Hub 216. At block 418, after repair (or when the ULDs do not require any repair), the IAUCT 202 moves these ULDs to the empty ULD Parking Hub 216 to wait for a next allocation, and saves ULD information to the ULD Repository Data Store 210 in FIG. 4E as indicated at line labeled ULD Status and location. At block 420, example ULD Supply process operations of method 400 are completed or end.

As shown in the example ULD Supply process operations of FIGS. 4C and 4F, the IAUCT 202 saves ULD information in the ULD Repository Data Store 210 that can include for example, an estimated time of arrival (ETA) for incoming ULDs, ULD state, location of the ULDs, and the like that is maintained by IAUCT 202. The IAUCT 202 keeps track of the ULDs and determines best actions, such as possible allocation based on the demands, and derives optimized allocation of the ULDs considering cost and time factors. The IAUCT 202 keeps track of empty ULD availability, ULD condition and ULD storage availability in a specific airport to determine optimized ULD allocation, identify ULDs that need to be repaired, and to determine if ULDs need to be moved to different location for storage.

Referring now to FIG. 4A, ULD Demand and Fulfillment process operations of method 400 start at block 431. At block 432, a Customer initiates a ULD booking with a specific Carrier containing information about source, destination, volume and quantity, shipment date range, cargo type and the like. At block 433, the Carrier creates or updates a demand based on Carrier's aircraft availability at the origin location. The Carrier derives data elements for the ULD demand at block 433, such as Number of ULDs required along with ULD Type, Airport where required, Date and time and Shipment window for the incoming demand to query IAUCT 202 for best match.

Referring also to FIG. 4B at a routine block 434, the IAUCT 202 receives the ULD demand placed by the Carrier at block 433 in FIG. 4A. The IAUCT 202 centrally manages data of the ULDs for all on-boarded Airports. At block 434, the IAUCT 202 searches in ULD Repository 210 to find a best possible cost and time effective match. At decision block 436, the IAUCT 202 checks for a match for the ULD demand. When a complete match is found at decision block 436 with the ULDs available within origin Airport on the given date and time the IAUCT 202 can send ULD location with availability and price to confirm booking to a decision block 438 and a block 440 to Block Allocation in FIG. 4A.

Referring again to FIG. 4A and FIG. 4D, at decision block 438, the IAUCT 202 checks for the confirmed booking. At block 440 in FIG. 4A, the IAUCT 202 allocates selected available ULDs for the demand and blocks allocation of the selected ULDs to avoid selecting the ULDs for other ULD demands. At block 441 in FIG. 4D, the IAUCT 202 blocks the allocation for ULD transport autonomous vehicles for the demand. The IAUCT 202 monitors the ULD transport autonomous vehicles to determine the optimized movement of the ULDs based on the demand. At block 442 in FIG. 4A, when a match is not found at decision block 436 in FIG. 4B, the IAUCT 202 notifies Carrier to re-plan and reevaluate the demand. At block 444 in FIG. 4A, when a booking is not confirmed at decision block 438 in FIG. 4A, the IAUCT 202 releases the allocation for the Airport Terminal and at block 433 notifies the Carrier to create or update the demand. The Carrier and Customer can revise or revalidate the demand and resubmit the demand based on availability. At block 446 in FIG. 4D, the IAUCT 202 releases the allocation for ground transportation autonomous vehicles, and notifies the ULD Repository 210 to release the temporary allocation. At block 448 in FIG. 4A, the Customer can confirm the booking that is received by the IAUCT 202 at decision block 438. At decision block 438 when the booking confirmation is not found, or not confirmed within a given time, the IAUCT 202 notifies the Carrier to create or update the demand at block 433 in FIG. 4A.

Referring again to FIG. 4B, when a partial match is found at decision block 436, for example either some ULDs are not available on the given date; the IAUCT 202 determines if the ULDs can be transported, for example via ground transportation from other airports or within other perimeter areas. In addition, the IAUCT 202 determines if the ULDs are expected to be available within the order fulfillment window within the current airport or perimeter area. For example, the IAUCT 202 can send back alternative options, such as earliest possible fulfillment date, price, and ULD locations. In FIG. 4B at the routine block 434, the IAUCT 202 can receive an alternative ULD demand placed by the Carrier at block 433 in FIG. 4A and the IAUCT 202 processes the alternative ULD demand as described before. The IAUCT 202 places a temporary time bound or allocation block request to the associated Airports for ULDs, ULD transport autonomous vehicles, and on ULDs to avoid multiple bookings for the same entities while waiting for a final booking confirmation from the Carrier or Customer.

Referring to FIGS. 4A and 4D, when a confirmed booking is identified at decision block 438, at block 450 in FIG. 4A, the IAUCT 202 confirms Allocation of ULDs for the confirmed booking for the ULD demand. At block 452 in FIG. 4D, the IAUCT 202 confirms Allocation for the ULD Pickup Hub to the Airport Terminal. At block 454 in FIG. 4D, the IAUCT 202 confirms the allocation for ULD transport autonomous vehicles. At block 456 in FIG. 4D, the example Supply operations end.

While the foregoing is directed to embodiments of the present invention, other and further embodiments of the invention may be devised without departing from the basic scope thereof, and the scope thereof is determined by the claims that follow.

What is claimed is:

1. A method comprising:
identifying a unit load device (ULD) state and a specific ULD position for a ULD within a prescribed airport perimeter;
receiving a demand for an allocation of one or more ULDs within a perimeter area;
selecting a next action for the ULD based upon the demand for the allocation of one or more ULDs and based on the ULD state and the ULD position; and
dynamically identifying an optimized route for ULD pickup and delivery of the ULD within the prescribed airport perimeter based the selected next action.

2. The method of claim 1, further comprising:
storing the ULD state and the ULD position for the ULD in a ULD repository data store, and storing updated ULD state and the ULD position with processing ULD events.

3. The method of claim 1, wherein identifying the ULD state comprises identifying one of an empty state, and a full state.

4. The method of claim 1, and wherein identifying the ULD state further comprises identifying a UDL health condition for ULD maintenance, and a ULD allocation status to a current demand.

5. The method of claim 1, wherein selecting a next action for the ULD further comprises identifying the next action for allocating the ULD to the demand.

6. The method of claim 1, wherein selecting a next action for the ULD further comprises moving the ULD to an identified one of a loading location, an unloading location, a ULD maintenance location and a parking location within the prescribed airport perimeter.

7. The method of claim 1, wherein selecting a next action for the ULD further comprises coordinating the next action of multiple ULDs, optimizing availability of the multiple ULDs and executing the next action on the ULD.

8. The method of claim 1, wherein selecting a next action for the ULD further comprises moving the ULD to a ULD maintenance location for repair.

9. The method of claim 1, wherein dynamically identifying an optimized route for ULD pickup and delivery within the prescribed airport perimeter further comprises enabling an autonomous vehicle to pick up and deliver the ULDs within the perimeter area based upon the identified route within the prescribed airport perimeter.

10. The method of claim 1, further comprises providing an Intelligent Autonomous ULD Control Tower (IAUCT) to receive demands for ULDs, to maintains a ULD repository data store, and to manage multiple ULDs within the prescribed airport perimeter.

11. A system, comprising:
a processor; and
a memory, wherein the memory includes a computer program product configured to perform operations for implementing intelligent decision making autonomous control of Unit Load Devices (ULDs) within a prescribed airport perimeter, the operations comprising:
identifying a unit load device (ULD) state and a specific ULD position for a ULD within a prescribed airport perimeter;
receiving a demand for an allocation of one or more ULDs within a perimeter area;
selecting a next action for the ULD based upon the demand for the allocation of one or more ULDs and based on the ULD state and the ULD position; and
dynamically identifying an optimized route for ULD pickup and delivery of the ULD within the prescribed airport perimeter based the selected next action.

12. The system of claim 11, further comprising:
storing the ULD state and the ULD position for the ULD in a ULD repository data store, and storing updated ULD state and the ULD position with processing ULD events.

13. The system of claim 11, wherein identifying the ULD state comprises identifying at least one of an empty state, a full state, a UDL health condition for ULD maintenance, and a ULD allocation status to the ULD current demand.

14. The system of claim 11, wherein selecting a next action for the ULD further comprises identifying the next action for allocating the ULD to the demand, and moving the ULD to an identified one of a loading location, an unloading location, a ULD maintenance location and a parking location within the prescribed airport perimeter.

15. The system of claim 11, wherein dynamically identifying an optimized route for ULD pickup and delivery within the prescribed airport perimeter further comprises enabling an autonomous vehicle to pick up and deliver the ULDs within the perimeter area based upon the identified optimized route within the prescribed airport perimeter.

16. A computer program product for implementing intelligent decision making autonomous control of Unit Load Devices (ULDs) within a prescribed airport perimeter, the computer program product comprising:
a computer-readable storage medium having computer-readable program code embodied therewith, the computer-readable program code executable by one or more computer processors to perform an operation comprising:
identifying a unit load device (ULD) state and a specific ULD position for a ULD within a prescribed airport perimeter;
receiving a demand for an allocation of one or more ULDs within a perimeter area;
selecting a next action for the ULD based upon the demand for the allocation of one or more ULDs and based on the ULD state and the ULD position; and
dynamically identifying an optimized route for ULD pickup and delivery of the ULD within the prescribed airport perimeter based the selected next action.

17. The computer program product of claim 16, further comprising:
storing the ULD state and the ULD position for the ULD in a ULD repository data store, and storing updated ULD state and the ULD position with processing ULD events.

18. The computer program product of claim 16, wherein identifying the ULD state comprises identifying at least one of an empty state, a full state, a UDL health condition for ULD maintenance, and a ULD allocation status to the ULD current demand.

19. The computer program product of claim 16, wherein determining a next action for the ULD further comprises identifying the next action for allocating the ULD to the demand, and moving ULD to an identified one of a loading location, an unloading location, a ULD maintenance location and a parking location within the prescribed airport perimeter.

20. The computer program product of claim 16, wherein dynamically identifying an optimized route for ULD pickup and delivery within the prescribed airport perimeter further comprises enabling an autonomous vehicle to pick up and deliver the ULD within the perimeter area based upon the identified optimized route.
